(19) United States
(12) Patent Application Publication
(10) Pub. No.: US 2019/0239989 A1
(43) Pub. Date: Aug. 8, 2019

(54) CAP FOR FASTENING ON AN ANCHORING ELEMENT

(71) Applicant: bredent GmbH & Co. KG, Senden (DE)

(72) Inventors: Wilfried BOEHM, Senden (DE); Peter BREHM, Senden (DE)

(73) Assignee: bredent GmbH & Co. KG, Senden (DE)

(21) Appl. No.: 16/319,892

(22) PCT Filed: Sep. 5, 2017
(86) PCT No.: PCT/EP2017/072160

§ 371 Date: Jan. 23, 2019

(30) Foreign Application Priority Data
Sep. 30, 2016 (DE) 10 2016 118 668.6

(51) Int. Cl. A61C 13/265; A61C 8/00

(52) U.S. Cl. CPC A61C 13/2656; A61C 8/008; A61C 8/0062

(57) ABSTRACT

A cap for fastening a denture on an anchoring element has a projecting part pointing radially inwards which co-operates with a circumferential groove on the anchoring element, thus forming a retention element such that the cap can be releasably fastened on the anchoring element. The cap has a conical end portion located below the retention element, the end portion at least partially surrounding, in the fastened state, a corresponding outer surface of the anchoring element.

The invention relates to a cap for attachment of a dental prosthesis onto an anchoring element.

Removal dental prostheses are used to fix a dental prosthesis or splint in place on implants or root pins. A removable dental prosthesis is often made available in the form of what is called a double crown, which has a conical part on the jaw side and a corresponding counter-cone on the dental prosthesis, which enter into a corresponding releasable connection with a slight opening angle, similar to a Morse taper. However, such a double crown is unsuitable for industrial production, due to the required tolerances.

In other systems, what are called ball heads, also referred to as patrices, are made available. Dental prostheses that possess a cavity that matches the ball head are set onto these ball heads, wherein the part of the dental prosthesis that faces the patrices is generally referred to as a matrix. The cavity in the prosthesis is frequently lined with an elastic material, for the purpose of setting it on, which material ensures sufficient pull-off forces between the ball head and the prosthesis. Therefore, the possibility exists, for the patient or the dentist, of removing the dental prosthesis for adjustment or cleaning purposes.

From DE 103 20 474 A1, a connection element between a removable prosthesis and dental implants or natural teeth or tooth roots is known, which has what is called a bollard profile, and serves for retention of the dental prosthesis on the implants or teeth. In this regard, the connection element consists of a conical primary part composed of a metallic or ceramic material, and is firmly connected with the implant or tooth. Furthermore, the connection element has a region that goes below itself, and thereby guidance and retention of the removable dental prosthesis is achieved in connection with the secondary part, which consists of plastic that remains soft.

From DE 199 45 354 C2, an implant-supported dental prosthesis is known, which has multiple base recesses in its basic body, in which recesses a cone cap composed of self-hardening plastic is embedded. Each cone cap possesses on a cone journal of an abutment coping, which is inserted into a cone bore of an endosseal implant. Pre-finished parts are exclusively used for production of the dental prosthesis. Embedding of the cone caps into the basic body of the dental prosthesis takes place in a single session in the dental practice, and after that, the dental prosthesis is complete.

From EP 0 707 835 A1, a mechanical connection of a two-phase dental implant is known, which consists of two components, which are connected by means of a cone journal that projects into a cone sheath, wherein the cone pairing is designed in the range of self-inhibition, and the cone journal has a traction bolt passing through it, which bolt runs centrally and is tapered, and braces the cone pair against one another.

From EP 1 086 662 B1, an implant-supported dental prosthesis having multiple abutment copings, each accommodated in an accommodation bore of an endosseal implant, is known, which copings have an occlusal cone journal for connection with the dental prosthesis, in each instance. Furthermore, the dental prosthesis has cone caps embedded in the basal recesses of the basic body of the dental prosthesis, which recesses have a cone bore adapted to the related cone journal assigned to them, in each instance. Each cone cap projects into a basal recess that is larger, on all sizes, than the cone cap to be accommodated, and is provided with a lateral filling opening.

From U.S. Pat. No. 5,556,280, an apparatus for releasable attachment of a dental prosthesis in the mouth of a patient is known. An abutment has a tapering support surface, which faces away from the attachment surface. The tapering support surface is configured in such a manner that it can be joined together with a corresponding surface of a dental prosthesis, so that these together can form an attachment for the dental prosthesis, so that the dental prosthesis does not need to be attached by means of adhesive surfaces.

From WO 2004/004 594 A1, a dental prosthesis arrangement is known, which has an abutment for attachment to a tooth root, an implant, an adjacent tooth or a splint, and comprises a retention element for articulated attachment in a cap, which element secures the dental prosthesis arrangement. An edge strip projects out of one end of the cap, so as to create a releasable snap connection by way of an outer attachment surface of the abutment. The outer attachment surface has at least two axially adjacent retention surfaces, which engage into one another and make available the snap attachment with the corresponding inner surface of the cap.

The aforementioned systems make it possible to create a removable dental prosthesis that can be removed by the dentist or the user for adjustment or cleaning purposes. However, there is a need, in the technical field, for creating releasable attachment possibilities that can be produced in simple and cost-advantageous manner, wherein the holding force can be corresponding adjusted, however.

It is therefore the task of the invention to create attachment possibilities for removable dental prostheses, which is configured in particularly simple manner, but nevertheless allows secure attachment of the dental prostheses with simultaneous coordination ability of the pull-off forces.

This task is accomplished by the characteristics of the independent claim 1. Further advantageous embodiments of the invention are the object of the dependent claims, in each instance. These can be combined with one another in technically practical manner. The description, particularly in connection with the drawing, additionally characterizes and specifies the invention.

According to the invention, a cap for attachment of a dental prosthesis on an anchoring element is indicated, wherein the cap has a projection that is directed radially inward, which projection interacts with a circumferential groove on the anchoring element as a retention element, so that the cap can be releasably attached to the anchoring element, and the cap has an end portion disposed below the retention element, which at least partially surrounds a corresponding outer surface of the anchoring element in the attached state.

Accordingly, a cap is described that can function as a support for a dental prosthesis. The cap has a retention region in its upper region, the design of which ensures a pull-off force that can be coordinated. Below the retention region, the cap makes a transition into an end portion, which can cover corresponding outer surfaces on the anchoring element, so that in the attached state, secure hold to prevent tilting is provided by the fact that the end portion is surrounded on outer surfaces of the anchoring element. Furthermore, the anchoring element has an undercut in the form of a groove, which interacts with a projection that is directed inward, so that together with the matrix, a firm hold of the cap on the anchoring element is made possible. The cap according to the invention therefore makes the desired holding force available with a retention element that can be produced industrially without any greater effort, wherein simultaneously, a clear improvement with regard to tilting stability is additionally achieved by way of the support on the conical end portion. The cap according to the invention therefore combines the advantages with regard to holding ability of a retention element with the tilting stability of a conventional double crown, but without having the individual disadvantages of the latter.

According to an embodiment of the invention, the cap is releasably attached to the anchoring element by means of a matrix produced from a resiliently elastic material. Plastic, for example, can be used as an elastically deformable material.

Plastic matrices are widespread in dental technology and allow secure and reliable hold of the cap on the anchoring element.

According to a further embodiment of the invention, the end portion is configured in the form of a truncated cone or a cylinder.

Use of a truncated cone or a cylinder allows rotation-symmetrical production of the cap, so that it has a particularly simple structure.

According to a further embodiment of the invention, the anchoring element has a circumferential groove, which interacts with a projection disposed on the cap.

According to a further embodiment of the invention, the projection directed radially inward and the circumferential groove are adapted to a pull-off force with regard to their dimensions.

In this regard, the projection that is directed inward and the circumferential groove can be dimensioned accordingly, so that the pull-off force to be applied to pull the cap off from the anchoring element can be coordinated in accordance with the requirements of the dental restoration.

The outside of the cap can be configured in the form of a bollard.

Such a configuration of the cap allows a firm seat of the dental prosthesis on the cap.

In this regard, the cap can be produced from metal or plastic, wherein other materials are not excluded.

Usually, the anchoring element is made available as part of an implant or root pin. Accordingly, the cap according to the invention can be used in many application cases, wherein an interaction with already existing implants or root pins is also possible.

The invention will be explained in greater detail in the following, making reference to the drawing. The drawing shows:

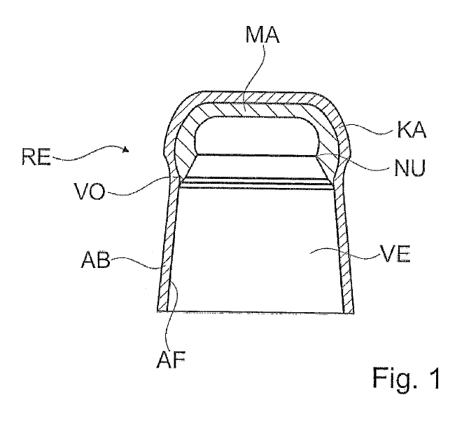

FIG. 1 a cap according to the invention, in a side view, in an attached state.

In the FIGURES, elements that are the same or have the same effect are provided with the same reference symbols.

In FIG. 1, an embodiment of a cap KA according to the invention is shown. The cap KA is attached onto an anchoring element VE, wherein a projection VO directed inward, on the cap KA, interacts with a groove NU on the anchoring element VE as a retention element RE. A matrix MA produced from elastically deformable material, typically a plastic material, is affixed between cap KA and anchoring element VE. Below the retention element RE, the cap KA has a conical end portion AB, which covers a corresponding outer surface AF of the anchoring element VE in the attached state.

Thereby, in the attached state that is shown in FIG. 1, the cap is not only held in the retention element RE but also additionally stabilized to prevent tilting, by way of the interaction of the conical end portion AB and the corresponding outer surface AF. In this regard, the outside of the cap KA can be configured in the form of a bollard, wherein the constriction that is typical for bollards can be formed in simple manner, in the region of the projection VO that is directed inward. Aside from a conical end portion AB, it would also be possible to provide a cylindrical geometry at this location.

The cap KA is provided as an attachment for a dental prosthesis (not shown in FIG. 1), so that a releasable connection with the anchoring element VE is created, as is desirable in the case of a removable dental prosthesis. The pull-off force can be determined by means of the dimensioning of the projection VO and its interplay with the groove NU or by means of the selection of the matrix material MA, so that different values can be achieved. The cap KA for attachment of a dental prosthesis is shown in an attached state on the anchoring element state in FIG. 1. In this regard, it should be emphasized that the cap KA can be pulled off upward in the axial direction. In this regard, the anchoring element VE can be part of an implant or of a root pin. Typically, metal or plastic is selected as the production material for the cap KA. It is advantageous if the cap KA is configured with rotation symmetry along the axial direction of the anchoring element VE.

The cap KA shown in FIG. 1 can, however, also be part of a dental prosthesis arrangement, and in this case would form an inner surface of the dental prosthesis.

Because of the simple structure, the cap KA allows a cost-advantageous attachment possibility for dental prostheses, wherein reliable attachment is achieved by means of the retention region RE, and securing to prevent tilting is achieved by way of the corresponding surfaces of the superimposition, in the form of a truncated cone, of cap KA and anchoring element VE, in the region of the end portion AB.

The characteristics indicated above and in the claims, as well as those that can be derived from the FIGURES, can be advantageously implemented both individually and in various combinations. The invention is not restricted to the exemplary embodiments described, but rather can be modified in many ways, within the scope of the ability of a person skilled in the art.

1. A cap for attachment of a dental prosthesis onto an anchoring element (VE), wherein the cap (KA) has a projection (VO) that is directed radially inward, which projection interacts with a circumferential groove (NU) on the anchoring element (VE) as a retention element (RE), so that the cap (KA) can be releasably attached to the anchoring element (VE), and the cap (KA) has an end portion (AB) disposed below the retention element (RE), which at least partially surrounds a corresponding outer surface (AF) of the anchoring element (VE) in the attached state.

2. The cap according to claim 1, in which the cap (KA) is releasably attached on the anchoring element (VE) by means of a matrix (MA) produced from a resiliently elastic deformable material.

3. The cap according to claim 2, in which the matrix (MA) is made of plastic.

4. The cap according to claim 1, in which the end portion (AB) is configured in the form of a truncated cone or in the form of a cylinder.

5. The cap according to claim 1, in which the outside of the cap is configured in the form of a bollard.

6. The cap according to claim 1, which has rotation symmetry along an axial direction.

7. The cap according to claim 1, in which the projection (VO) that is directed radially inward and the circumferential groove (NU) are adapted to a pull-off force with regard to their dimensions.

8. The cap according to claim 1, wherein the cap is produced from metal or plastic.

9. The cap according to claim 1, wherein the anchoring element is part of an implant or root pin.
